(19) United States
(12) Patent Application Publication
(10) Pub. No.: US 2024/0221088 A1
(43) Pub. Date: Jul. 4, 2024

(54) SYSTEMS AND METHODS FOR SYNTHETIC DATA ENTRY IN ONLINE REPORTS

(71) Applicant: Coupa Software Incorporated, San Mateo, CA (US)

(72) Inventors: Doug Benson, Burlingame, CA (US); Dan Benson, San Clemente, CA (US); Nikki Gupta, San Mateo, CA (US); Dipeshkumar Prajapati, Pune (IN)

(21) Appl. No.: 18/541,488

(22) Filed: Dec. 15, 2023

Related U.S. Application Data
(60) Provisional application No. 63/436,501, filed on Dec. 31, 2022.

(51) Int. Cl. G06Q 40/12; G06Q 10/10

(52) U.S. Cl. CPC G06Q 40/12; G06Q 10/10

(57) ABSTRACT

A computer-implemented method uses an expense reporting application for querying a travel planning application to provide a planned trip record and receiving the planned trip record in response. The expense reporting application and the travel planning application are among a plurality of federated applications that are hosted using a multi-tenant distributed computing system. The method further determines event data comprising a plurality of schedule values for each distinct location among a plurality of locations, from the planned trip record. An expense record having travel segments is created or updated based on the event data and associated with the plurality of distinct locations. For each travel segment, one or more daily allowed expense items are automatically determined based on a plurality of digitally stored per diem reimbursement rules and the expense record is automatically updated to specify the allowed expense items as expense line items in the expense record.

### BENEFIT CLAIM

This application claims the benefit under 35 U.S.C. § 119(e) of provisional patent application 63/436,501, filed Dec. 31, 2022, the entire contents of which are hereby incorporated by reference as if fully set forth herein. Applicant hereby rescinds any disclaimer of claim scope in the application(s) of which the benefit is claimed and advises the USPTO that the present claims may be broader than any application(s) of which the benefit is claimed.

### COPYRIGHT NOTICE

A portion of the disclosure of this patent document contains material subject to copyright protection. The copyright owner has no objection to the facsimile reproduction by anyone of the patent document or the patent disclosure, as it appears in the Patent and Trademark Office patent file or records, but otherwise reserves all copyright or rights. © 2022 Coupa Software Incorporated.

### TECHNICAL FIELD

One technical field of the present disclosure is computer-implemented, synthetic data entry in online reports to automatically enter or transfer data from one application to another in a federated system. Another technical field is automated expense reporting applications capable of processing travel data. Another technical field is automatically updated graphical user interfaces showing synthetic data entry.

### BACKGROUND

The approaches described in this section are approaches that could be pursued but not necessarily approaches that have been previously conceived or pursued. Therefore, unless otherwise indicated, it should not be assumed that any approaches described in this section qualify as prior art merely by their inclusion.

Enterprises commonly pay or reimburse the cost of travel by employees, which is necessary to support business operations. Travel costs typically are subject to budgets, caps, policies, or other controls. In present practice, employees commonly spend significant time trying to estimate travel costs from multiple suppliers and resources before submitting a request for preapproval of a proposed trip or a planned trip. Further, employees may lack sufficient time or resources to submit a travel request with accurate cost guidance other than what is provided in policies or booking tools. Managers often have limited information in the pre-travel stage to accurately decide whether to approve a trip or to determine what costs or budget the trip will consume.

When travel occurs, depending on enterprise policy, individuals may be entitled to reimbursement for the cost of meals and other incidental expenses at caps or limits per day. Based on the Latin meaning of “per day,” these reimbursements are known as “per diem expenses” or just “per diems.” The allowed amount of a per diem reimbursement can vary widely based upon the location of travel, the nature of a trip, the rank or role of an individual, or other factors, resulting in complex business rules to determine whether a per diem is allowed.

Many enterprises also use or operate independent software applications to manage expense reporting and travel planning. Consequently, transferring travel-related data, including per diem items, to an expense report can involve multiple manual steps. For example, existing systems could require a user to manually enter per diem information in a trip plan field associated with the itinerary after a manual review of per diem rules. Such a process will involve a significant time when multiple trip segments occur. Furthermore, existing methods involve excessive use or waste of computer resources, such as CPU cycles, network bandwidth, non-volatile storage, and volatile memory, when a user submits a trip itinerary in a travel application and then separately enters reimbursable expenses in an expense application.

Based on the foregoing shortcomings, enterprises have developed an acute need for more efficient means of entering data for per diem expenses in an expense application based on a separate travel application, with the automatic evaluation of per diem reimbursement rules.

### SUMMARY

The appended claims may serve as a summary of the invention.

### BRIEF DESCRIPTION OF THE DRAWINGS

In the drawings:

FIG. 1 illustrates a distributed computing system with which one embodiment can be implemented;

FIG. 2 illustrates a process flow or algorithm that can be programmed to evaluate per diem expense allowance according to an embodiment;

FIG. 3 illustrates a process flow or algorithm that can be programmed to trigger application programming interface (API) calls for determining expense records with trip segments, according to an embodiment;

FIG. 4 illustrates a portion of a graphical user interface with a visual presentation of a planned trip record associated with distinct locations, according to an embodiment;

FIG. 5 illustrates a portion of a graphical user interface with a visual presentation for indicating work in process for querying and extracting planned trip records, according to an embodiment;

FIG. 6 illustrates a portion of a graphical user interface with a visual presentation for indicating a prompt associated with creating or updating an expense record, according to an embodiment;

FIG. 7 illustrates a portion of a graphical user interface for evaluating allowed expense items as expense line items in expense records based on the selection of different expense items, according to an embodiment;

FIG. 8 illustrates a portion of a graphical user interface showing expense trip segments, according to an embodiment; and

FIG. 9 illustrates a computer system with which one embodiment could be implemented.

### DETAILED DESCRIPTION

In the following description, for clarity, numerous specific details are set forth to provide a thorough understanding of the present invention. It will be apparent, however, that the present invention may be practiced without these specific details. In other instances, well-known structures and devices are shown in block diagram form to avoid unnecessarily obscuring the present invention.

The text of this disclosure, in combination with the drawing figures, is intended to state in prose the algorithms that are necessary to program the computer to implement the claimed inventions at the same level of detail that is used by people of skill in the arts to which this disclosure pertains to communicate with one another concerning functions to be programmed, inputs, transformations, outputs and other aspects of programming. That is, the level of detail outlined in this disclosure is the same level of detail that persons of skill in the art normally use to communicate with one another to express algorithms to be programmed or the structure and function of programs to implement the inventions claimed herein.

Embodiments are described in sections according to the following outline:
1.0 GENERAL OVERVIEW
2.0 STRUCTURAL & FUNCTIONAL OVERVIEW
3.0 EXAMPLE GRAPHICAL USER INTERFACE
4.0 IMPLEMENTATION EXAMPLE—HARDWARE OVERVIEW

### 1.0 General Overview

Embodiments are programmed for automatically identifying travel segments in travel planning data of a travel planning system, automatically determining per diem allowances for meals or other items that are subjected to per diem reimbursement or caps, and automatically inserting records for expenses, reimbursements, or cost caps into an expense reporting system that is separate from the travel planning system. In one embodiment, a computer-implemented method is programmed to automatically determine one or more daily allowed expense items based on digitally stored per diem reimbursement rules and/or policies. Embodiments are useful in enterprises or with systems that provide for reimbursements of expenses but in which travel planning and/or travel bookings occur independently of expense reporting.

In an embodiment, a method of evaluating per diem entries and daily allowed per diem expenses for travel planning records and/or travel bookings is programmed to adapt to multiple distinct locations or trip segments, each associated with digital data defining a plurality of schedule values. The plurality of schedule values may include an arrival time, arrival date, departure time, and departure date. In an embodiment, the method is programmed to automatically evaluate daily allowed per diem expenses based on lodging event data and movement or transit event data obtained from a travel planning system. The lodging event data may include lodging location data, such as city and country name, check-in time relative to arrival date and arrival time, and check-out time relative to the departure date and departure time. The movement or transit event data may be associated with rental transportation and can have values such as pickup date, pickup time, pickup location, return date, return time, and return location. Parameter values of the foregoing types can collectively define one or more travel segments of a trip itinerary.

In one embodiment, an allowed per diem expense is calculated automatically based on each of the one or more travel segments, which can be associated with multiple distinct locations to which different per diem reimbursement rules apply. In an embodiment, the per diem allowance is automatically determined for each travel segment and is used for updating an expense record having one or more travel segments to specify the per diem allowance expense items as expense line items in the expense record for each travel segment. The per diem allowance expense associated with the daily allowed expense items is evaluated for use in pre-approving, post-approving, and/or per diem guidance for travel planning and/or travel bookings.

In an embodiment, a computer-implemented method is disclosed for automatically evaluating the per diem allowance expense associated with the daily allowed expense items for each travel segment that is associated with multiple pieces of itineraries and presenting the daily allowed expense items as expense line items in the expense record along with each travel segment and itinerary on a graphical user interface (GUI) for reviewing and/or updating. In various embodiments, aspects, and features, the disclosure encompasses the subject matter of the following numbered clauses:

1. A computer-implemented method comprising using an expense reporting application, querying a travel planning application to provide a planned trip record, and receiving the planned trip record in response, the expense reporting application being a first application of a plurality of federated applications hosted using a multi-tenant distributed computing system the travel planning application being a second application among the plurality of federated applications; using the expense reporting application, determining from the planned trip record, event data comprising a plurality of schedule value specifying an arrival date value, an arrival time value, a departure date value, and a departure time value, for each distinct location among a plurality of locations; using the expense reporting application, creating an expense record having one or more travel segments based on the event data and associated with the plurality of distinct locations; using the expense reporting application, based on a plurality of digitally stored per diem reimbursement rules, automatically determining one or more daily allowed expense items for each travel segment of the one or more travel segments and automatically updating the expense record to indicate the one or more daily allowed expense items as expense line items in the expense record.

2. The method of clause 1, further comprising using the expense reporting application, executing the steps of clause 1 in response to receiving an input specifying a request to add details of the planned trip record that has been previously created in the travel planning application.

3. The method of clause 1, further comprising using the expense reporting application, executing the steps of clause 1 as part of a per diem modal function that is implemented as a programmatic function; and generating and transmitting to a user computer sequences of presentation instructions which, when executed using the user computer, cause displaying a prompt to review and update an imported trip itinerary.

4. The method of clause 1, wherein the plurality of per diem reimbursement rules specify a plurality of per diem categories, each of the plurality of per diem categories comprising a user role value, an eligibility value, one or more per diem items, and one or more per diem limit values corresponding to each of the per diem items.

5. The method of clause 3, further comprising receiving, from a user account, a request to launch the expense reporting application; and using the expense reporting application, based on a plurality of digitally stored per diem reimbursement rules, matching the user account to a particular user role value, and automatically determining the one or more daily allowed expense items for each travel segment of the one or more travel segments only when the eligibility value associated with the particular user role value indicates eligibility.

6. The method of clause 3, further comprising digitally storing in one or more trip event groups, the event data comprising the plurality of schedule values for each distinct location among the plurality of distinct locations, wherein the one or more trip event groups of the event data are classified based on any of: any missing information determined from the planned trip record and the event data associated with the plurality of distinct locations, and the review and the update of the imported trip itinerary.

7. The method of clause 6 further comprising indicating the prompt to review and update the imported trip itinerary and the event data with at least one of one or more prompt indicators.

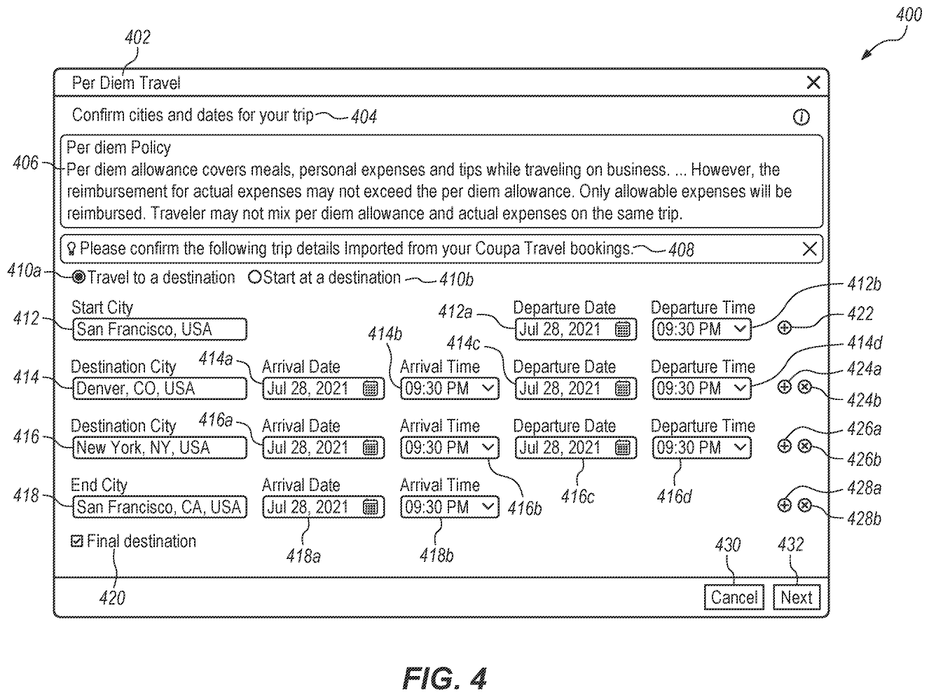

8. A computer-implemented method describing to execute a method of evaluating daily allowed per diem expense associated with the planned trip record corresponding to trip itineraries and displaying them on a GUI with various associated event data along with a graphical bar with a prompt to review and update imported trip itineraries as shown and described in connection with FIG. 4.

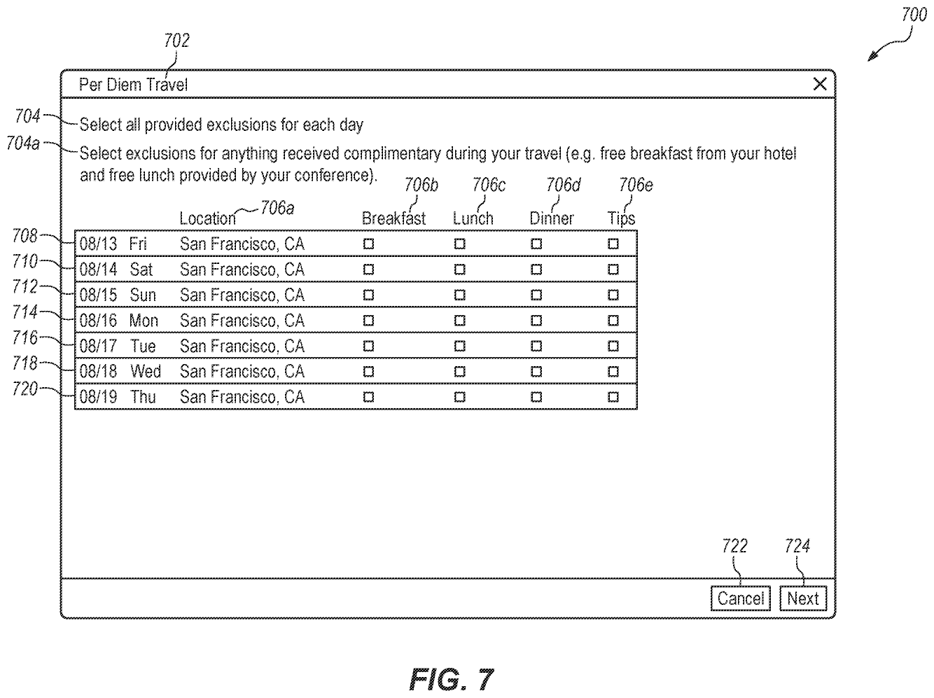

9. A computer-implemented method describing to executing method of evaluating daily allowed per diem expense associated with distinct locations in the planned trip record and per diem items with per diem limit values and displaying them on a GUI with various interface elements like checkboxes or radio buttons as examples as shown and described in connection with FIG. 7.

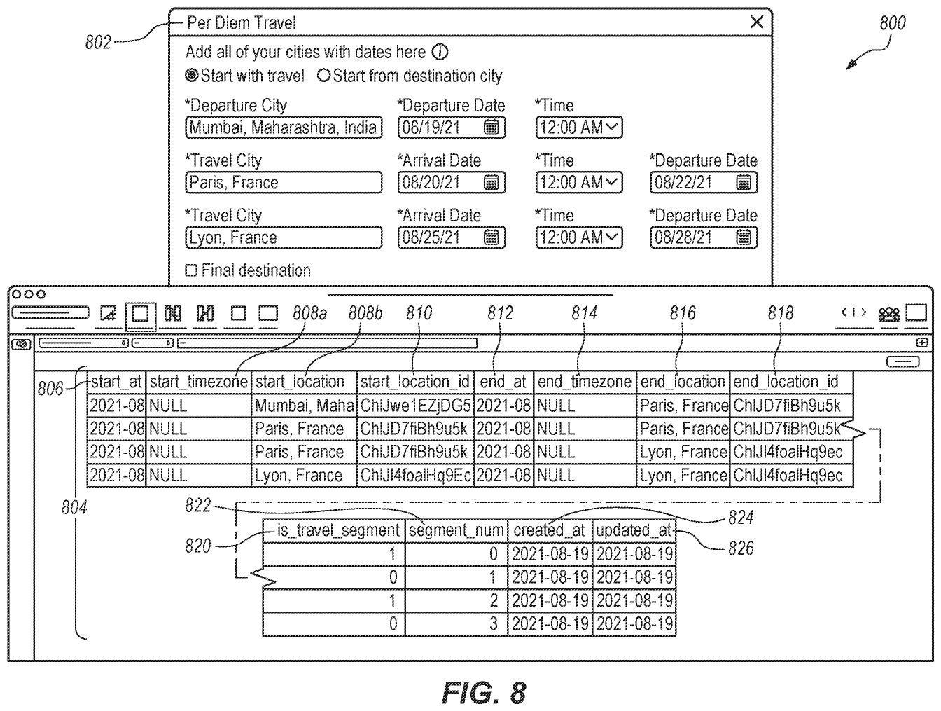

10. A computer-implemented method describing to execute the method of creating and/or updating an expense record having one or more travel segments based on the event data and associated with the plurality of distinct locations and displaying expense trip segments on a GUI as shown and described in connection with FIG. 8.

11. One or more non-transitory computer-readable data storage media storing one or more sequences of instructions which, when executed using one or more processors, cause the one or more processors to execute the methods of any of clauses 1 to 7.

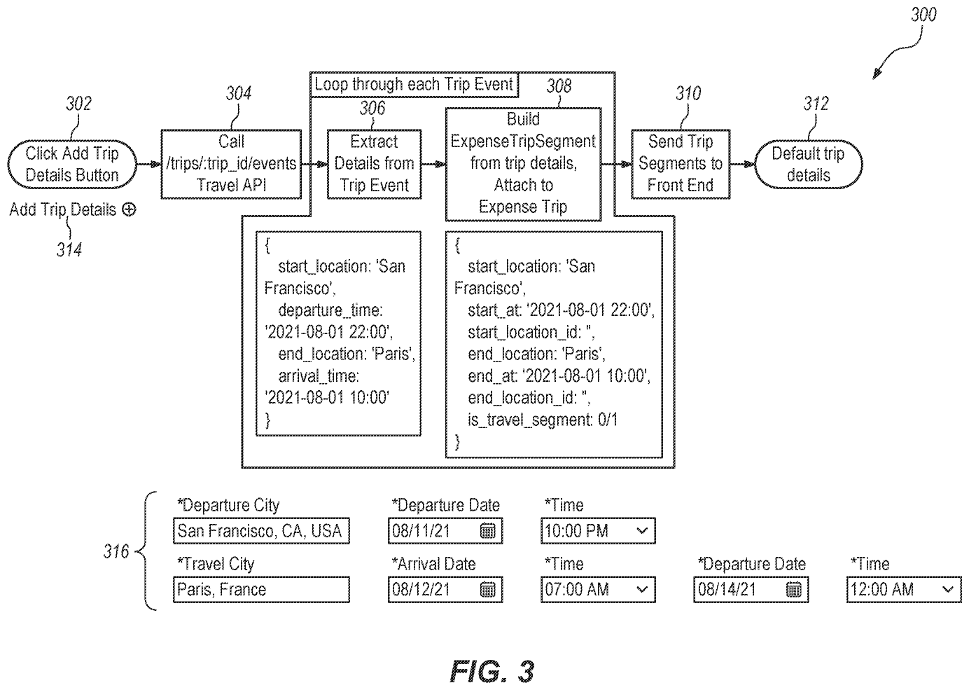

12. One or more non-transitory computer-readable data storage media storing one or more sequences of instructions which, when executed using one or more processors, cause the one or more processors to execute the methods of creating and/or updating an expense record having one or more travel segments based on the event data and associated with the plurality of distinct locations and displaying expense trip segments on a GUI as shown and described in connection with FIG. 3.

13. A distributed computing system, for example, a multi-tenant distributed computing system, comprising: one or more processors; one or more non-transitory computer-readable data storage media coupled to the one or more processors and storing one or more sequences of instructions which, when executed using the one or more processors, cause the one or more processors to execute the methods of any of clauses 1 to 7 using a plurality of federated applications of a federated system, for example, a travel planning application, and an expense reporting application.

Embodiments are useful for enterprises or entities that pay per diem rates to travelers based on locations, segments, and travel dates. In this context, with past systems, entering per diem information into an expense solution has been time-consuming. Users were required to manually enter multiple pieces of itinerary data to determine their daily allowance, and the greater the trip complexity, the longer the data took to enter. Therefore, enterprises commonly find that employees spend significant time estimating travel costs from multiple suppliers and resources before submitting a proposed travel plan or expense report for preapproval. “Preapproval,” in this context, refers to an approval to incur certain expenses before a trip or another event occurs in which the expenses are incurred. Preapproval is distinct from post-approval, in which an expense report of past incurred expenses is presented after a trip or other event and approved after the fact. Employees may also submit a travel request without accurate cost guidance, other than what is provided in enterprise policies or booking tools, based on lack of time and/or resources. Furthermore, managers typically have limited information at the pre-travel stage to make accurate decisions about potential budgetary impacts. Embodiments of the present disclosure provide solutions via automated methods for automatically determining per diem allowances for travel planning and/or travel bookings.

In one embodiment, a method is programmed to create or update an expense record having multiple travel segments associated with corresponding multiple trip itineraries for multiple distinct locations. The creation or updating of the expense record for any travel segment triggers determining the daily allowed per diem expenses accurately for each daily allowed expense item in the expense record. By automatically determining the daily allowed expense expenses for each daily allowed expense item according to each travel segment, users obtain a plurality of data useful to guide the user(s) or employees or submitter, account payable (AP) department, approver, and/or auditors. In an embodiment, an expense record specifying the daily allowed per diem expenses can be automatically evaluated during any later stages, such as preapproval, post-approval, and/or dynamically in real-time during the travel. Consequently, embodiments can reduce the time to prepare an expense record correctly. They can provide a significant reduction in the consumption of central processing unit (CPU) time, cycles, memory, other storage, or network bandwidth and network resources. Reduced use of resources occurs because the disclosed method utilizes an automated approach in determining trip details and mapping per diem and expenses associated with the daily allowed expense items to multiple pieces of itinerary data of the trip details.

Embodiments can provide the benefit of shared data between expense reporting applications and travel planning applications implemented as different but federated applications of a multi-tenant distributed computing system. Users associated with enterprises or entities can submit more accurate travel requests easily. Managers or approvers can be better equipped to approve or deny requests based on related per diem allowance policies and rules that may depend on per diem categories, a user role, an eligibility constraint, per diem items, and per diem limit corresponding to each of the per diem items. Consequently, the data relating to travel and expenses that enterprises store can be more accurately and efficiently stored.

Certain embodiments include providing a visual presentation of the expense record for each travel segment for each stage of a trip using a graphical user interface (GUI) associated with any of the employees and approvers, thus providing full transparency into the trip details and review the expense record including each per diem line and expense line items associated with the daily allowed expense items.

### 2.0 Structural & Functional Overview

### 2.1 Example Distributed Computing System Architecture

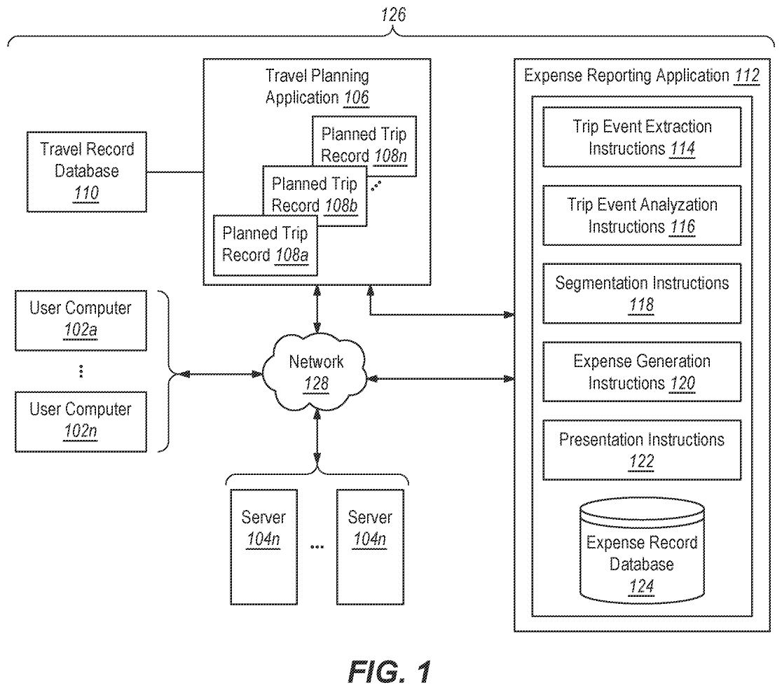

FIG. 1 illustrates a distributed computing system with which one embodiment can be implemented. In an embodiment, the distributed computing system 100 comprises components that are implemented at least partially by hardware at one or more computing devices, such as one or more hardware processors executing stored program instructions stored in one or more memories for performing the functions that are described herein. In other words, all functions described herein are intended to indicate operations performed using programming in a special or general-purpose computer in various embodiments. FIG. 1 illustrates only one of many possible arrangements of components configured to execute the programming described herein. Other arrangements may include fewer or different components, and the division of work between the components may vary depending on the arrangement.

According to one embodiment, an expense reporting application 112 is communicatively coupled to a travel planning application 106, which can be hosted using one or more server computers, other computing devices, and/or one or more virtual compute instances and storage instances that are coupled using a network 128, such as a packet data network. The computing devices may be hard-wired to perform the techniques or may include digital electronic devices such as at least one application-specific integrated circuit (ASIC) or field programmable gate array (FPGA) that is persistently programmed to perform the techniques or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body-mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

The drawing figures and all of the descriptions and claims in this disclosure are intended to present, disclose, and claim a technical system and technical methods in which specially programmed computers, using a special-purpose distributed computer system design, execute functions that have not been available before to provide a practical application of computing technology to the problem of predicting likely cost(s) and variance(s) from cost policy associated with a travel expense report or a set of proposed travel expenses. In this manner, the disclosure presents a technical solution to a technical problem, and any interpretation of the disclosure or claims to cover any judicial exception to patent eligibility, such as an abstract idea, mental process, method of organizing human activity, or mathematical algorithm, has no support in this disclosure and is erroneous.

In an embodiment, the distributed computing system 100 may be a multi-tenant distributed computing system. In an embodiment, distributed computing system 100 comprises one or more user computers 102a-102n and one or more servers 104a-104n, and each of them is communicatively coupled, directly or indirectly via one or more data communication networks 128, to the expense reporting application 112 and/or programmatically coupled to functional elements such as each instruction (114, 116, 118, 120, 122) within the expense reporting application 112. For clarity, FIG. 1 shows two user computers 102 and two servers 104 as an example, but in practical embodiments, computer system 100 can include thousands to millions of user computers and servers depending upon the processing capacity of CPUs or other hardware resources of the expense reporting application 112. The designation “n” in reference characters such as “102n” and “104n” means that in embodiments the actual number of elements corresponding to a reference character is unlimited.

Each of the user computers 102a-102n can comprise any kind of computing device, such as a desktop computer, laptop computer, tablet computer, mobile computing device, or workstation. In an embodiment, the one or more user computers 102-102n may be associated with one or more users, customers, candidates, applicants, submitters, employees, requesters, petitioners, personals, teams, and other computer users who are involved in requesting reimbursements and per diem allowances during a post-approval stage, pre-approving the reimbursements and per diem allowances, and to estimate per diem allowances dynamically in real-time automatically. Each of the users, customers, candidates, applicants, submitters, employees, requesters, petitioners, personals, teams, and other kinds of individuals requesting reimbursements and per diem allowances requests are specified with corresponding roles and eligibilities against which such requests for reimbursements and per diem allowances are evaluated and approved. The requests for reimbursements and per diem allowances requests can be submitted via digital electronic expense statements, for example, expense bills, debit and credit card bills, invoices, quotations, and any expense-related statements in the form of digital electronic documents. Throughout this disclosure, all references to “user” or “users” are specified for convenience but correspond to user accounts or user computers that execute the technical steps described in the disclosure. Thus, even where the terms “user” or “users” appear, all steps and functions of the disclosure are intended as computer-implemented steps or technical steps and not manual, mental, human-performed, or abstract steps, each of which is hereby expressly excluded from the scope of the claims and the disclosure.

In an embodiment, each of the user computers 102a-102n may interoperate with the servers 104a-104n that may be associated with one or more entities that may have payroll services, benefits services, Accounts Payable (AP) departments for reimbursing and/or funding the one or more users or employees for their travel or trip. The servers 104a-104n may be computing systems associated with auditors, approvers, examiners, inspectors, and accountants who oversee approving the requests for reimbursements and the per diem allowances during any post-approval, pre-approval, and/or dynamically in real-time. In one embodiment, the servers 104a-104n may be computers and other computing devices associated with travel booking entities, suppliers, and resources, for example, airline entities, train reservations and booking entities, hotel room reservation entities, rental car reservations entities, lodging entities, and other entities related to book and/or reserve, and/or appoint, related to travel domain such as travel plans and/or travel bookings.

The servers 104a-104n may also provide per diem policy data related to country-based, city-based, zone-based, and corresponding government-based per diem policy statistics, per diem rates, tax rates, excise rates, tolls, tariffs, prices, costs, charges, and other related per diem expenses that the one or more users may incur during their travel, and/or for travel plans and/or travel bookings. In an embodiment, the user computers 102a-102n and the servers 104a-104n accept API calls, or parameterized HTTP GET requests, that contain or encode queries to retrieve a planned trip record, including various multiple pieces of trip itineraries related to travel plans and/or travel bookings. For example, the planned trip record includes trip itineraries and booking information from various airline companies, train reservations, rental movement or transit bookings, and hotel reservations along with the arrival dates and times and departure dates and times associated with each of the bookings, the per diem policy data and so forth.

The user computers 102a-102n and the servers 104a-104n may interoperate and/or may be integrated with one or more distinct and diverse applications, directly or indirectly, that may be among a plurality of federated applications that may be integrated and programmed into a federated system 126. Each federated application of the plurality of federated applications may be hosted using the multi-tenant distributed computing system 100 and executed by the user computers 102a-102n and the servers 104a-104n via the data communication networks 128. For example, the plurality of federated applications of the federated system 126 may include, but are not limited to, a travel planning application 106 and the expense reporting application 112. The travel planning application 106 is associated with storing and providing one or more planned trip records 108a-108n created in response to the user bookings, reservations, and appointments for the travel plans and/or travel bookings. For example, the travel planning application 106 may also include information and details on the per diem policy data corresponding to the user bookings for the travel plans and/or the travel bookings.

Each record 108a-108n, along with corresponding per diem policy data, is stored in one or more memory units and data repositories associated with the travel planning application 106. For example, the memory units and data repositories associated with the travel planning application 106 are depicted as a travel record database 110 that can be a networked digital data storage such as digital data repositories. As an example, the travel record database 110 stores each of the records 108a-108n using any of a mapping table, lookup table, data structures, relational database, object database, flat file system, SQL database, or no-SQL database. In an embodiment, the travel record database 110 is a database that may be configured to be travel booking entities-specific, suppliers-specific, and resources-specific databases containing entries of the travel plans and/or the travel bookings according to entries of information of the users, customers, candidates, applicants, submitters, employees, requesters, petitioners, personals, teams, and other individuals associated with such travel plans and/or the travel bookings.

In an embodiment, the travel record database 110 is populated using replication or duplication entries from the user computers 102a-102n, the servers 104a-104n, and an expense record database 124 of the expense reporting application 112. The travel planning application 106 comprising the records 108a-108n may correspond to the travel plans and/or the travel bookings that were created in the past, or at present, and/or created for upcoming events and that are associated with either pre-approval and/or post-approval requests.

In an embodiment, the user computers 102a-102n and the servers 104a-104n may comprise one or more processors that are configured to implement all programming instructions that are programmed or configured to host or execute functions of the expense reporting application 112 in combination with optional travel planning application 106. For example, the user computers 102a-102n and the servers 104a-104n utilize each of the plurality of the federated applications, such as the travel planning application 106 and the expense reporting application 112, to automatically evaluate one or more daily allowed expense items for each travel segment and automatically update an expense record to specify the one or more daily allowed expense items as expense line items in the expense record corresponding to per diem allowances of travel plans and/or travel bookings.

In an embodiment, the federated system 126 may enable cross-referencing multiple pieces of travel plans and travel bookings, including user or submitter or employee information, trip itineraries, information of travel booking entities, suppliers, and resources, and associated per diem items and the information of per diem policy data related to country-based, city-based, zone-based, and corresponding government-based per diem policy statistics, per diem rates, tax rates, excise rates, tolls, tariffs, prices, costs, charges, and other related per diem expenses, to evaluate daily allowed expense items for each travel segment and update the expense record corresponding to the per diem allowances of travel plans and/or travel bookings. In an embodiment, such evaluation of per diem allowances of travel plans and/or travel bookings may be achieved in a single application of the federated applications that can execute all the functions of the expense reporting application 112 and the travel planning application 106.

The one or more user computers 102a-102n, the one or more servers 104a-104n, and the expense reporting application 112 in combination with the optional travel planning application 106 can be implemented using server computing technology such as a server farm, a cloud computing platform, or a parallel computer, one or more virtual compute instances and/or virtual storage instances, and/or instances of a server-based application. In an embodiment, each of the one or more user computers 102a-102n and the one or more servers 104a-104n executes application programs. The application programs can include a browser and other elements that can implement HTTP servers to interoperate with browsers, the expense reporting application 112, and the travel planning application 106. The browser can comprise any application program compatible with open protocols such as HTTP and HTML; commercially available examples include CHROME, SAFARI, EDGE, INTERNET EXPLORER, or FIREFOX.

In an embodiment, FIG. 1 shows the data communication networks 128 through which the user computers 102a-102n, the servers 104a-104n, the travel planning application 106, and the expense reporting application 112 can interoperate and exchange data. The data communication networks 128 enable accessing and procuring information and data from the travel record database 110 and the expense record database 124 of the expense reporting application 112 as well for evaluating requests for reimbursements and the per diem allowance expenses. The data communication network 128 may be implemented by any medium or mechanism providing data exchange between the various user computers and systems, including the expense reporting application 112. Examples of the data communication network 128 include, without limitation, any of a cellular network communicatively coupled with a data connection to the computing devices over a cellular antenna, a near-field communication (NFC) network, a Local Area Network (LAN), a Wide Area Network (WAN), the Internet, a terrestrial or satellite link, etc. The data exchanged may be formatted in various ways, including, for example, using HTML, CSS, Javascript, XML, JSON, etc.

In one embodiment, various systems of the multi-tenant distributed computing system and/or federated applications are integrated over the data communication network(s) 128 that may be accomplished using one or more data integration protocols. One possible integration protocol may use flat files (e.g., CSV flat files) uploaded to and downloaded from a secure file transfer protocol (SFTP) server operated by any user computer that can access and implement the expense reporting application 112. The flat files may be CSV files, for example, that contain the expense statements and bill data incurred for the travel plans and/or travel bookings. In another embodiment, another possible integration protocol for importing expense request information including, but not limited to, expense-related statements and bill data along with the planned trip records 108a-108n, multiple trip itineraries, the user information with roles and eligibilities data who is requesting the reimbursements or per diem allowance expenses, the policy data, and the travel booking entity, supplier, and resources information, and other information related to such reimbursements or per diem allowance expenses requests, is by using a REST API offered by servers associated with the expense reporting application 112. For example, the flat file integration protocol may be used for bulk import of supplier-customer information, and the REST API integration protocol may be used for real-time import of expense information.

The purpose of the integration may be to exchange data or to import the expense statements along with expense request information and its associated details to or from the expense reporting application 112. Such expense information imported to or from the user computers 102a-102n, the one or more servers 104a-104n, and the travel planning application 106 may be processed by various instructions stored in the expense reporting application 112, including instructions that implement techniques disclosed herein for automatically evaluating expense reimbursements and per diem allowance expenses requests and presenting each stage of such evaluation a GUI for viewing from the user(s) or request submitters and/or the request approvers.

In an embodiment, the expense reporting application 112 is implemented using one or more computing devices programmed for analyzing and processing the records 108a-108n and creating expense records associated with specifying expense reimbursements and/or the per diem allowance expenses. In various embodiments, the expense reporting application 112 can comprise any of a single-machine processor, multi-processor machine, a processor or machine cluster, and/or one or more virtual compute instances and/or virtual storage instances to process the records 108a-108n and automatically determine the per diem allowance expenses for creating or updating expense records corresponding to the per diem allowance expenses.

The expense reporting application 112 comprises or executes a web server including or comprising an HTTP server that can process user requests, transmit responses including HTML payloads with dynamically generated web pages, and can include a firewall, load balancer, or other infrastructure to manage a large number of requests from the user computers 102a-102n associated with the reimbursements requests and the per diem allowance expenses requests towards the travel plans and/or the travel bookings.

The expense reporting application 112 can execute in a multi-tenant, multi-instance architecture in which large numbers of requests from user computers 102a-102n are processed using separate or shared data storage with security controls. Further, the expense reporting application 112 can comprise a set of executable program instructions or units of instructions such as executables, binaries, packages, functions, methods, or objects that are hosted on one or more virtual computing instances of public data centers, private datacenters, or cloud computing facilities. The expense reporting application 112 can be programmed to execute per-tenant basis procurement and evaluation functions, where per-tenant corresponds to multi-tenant environments including various companies, industries enterprises, and entities that may be large-scale or small-scale enterprises. Further, per-tenant corresponding to the multi-tenant environments may be associated with the users, customers, candidates, applicants, submitters, employees, requesters, petitioners, personals, teams, and other kinds of individuals who are requesting reimbursements and per diem allowances. The expense reporting application 112 can execute per-tenant-specific expense requests for information including, but not limited to, expense-related statements and bill data along with the one or more planned trip records 108a-108n, multiple trip itineraries, the user information with roles and eligibilities data about who is requesting the reimbursements or per diem allowance expenses, the policy data, and the travel booking entity, supplier and resources information, and other information for determining per diem allowance for user travel plans and/or travel bookings.

FIG. 1 illustrates example components of the expense reporting application 112 in one embodiment. In various embodiments, one or more functional components can be implemented as software components, general or specific-purpose hardware components, firmware components, or any combination thereof. The expense reporting application 112 can be programmed as multiuser software-as-a-service (SaaS) applications that interoperate with user computers 102a-102n, the servers 104a-104n, and the travel planning applications including other applications that are part of the federated system 126, via browsers. A commercial example of the expense reporting application is the Coupa Travel & Expenses platform of Coupa Software Incorporated, San Mateo, California, but other embodiments need not implement every feature or function of Coupa.

In an embodiment, the expense reporting application 112 is communicatively coupled with the expense record database 124, which can be a relational database programmed to store various travel-related data, for example, expense-related statements and bill data along with the planned trip records 108a-108n, multiple trip itineraries, the user information with roles and eligibilities data about who is requesting the reimbursements or per diem allowance expenses, the policy data applicable for determining per diem allowance, and the travel booking entity, supplier, and resources information, and other information for determining per diem allowance for user travel plans and/or travel bookings. The expense record database 124 may store various enterprise-specific and government-specific per diem reimbursement rules and policies that are applied to determine daily allowed expense items for each travel segment and updating expense records to specify the one or more daily allowed expense items as expense line items in the expense record for the user travel plans and/or travel bookings. While the expense record database 124 is specified as the relational database as an example, other embodiments can use any combination of large-scale digital data storage devices or systems, including object stores, flat file systems, or no-SQL databases, including any combination of those from SPARK, AMAZON AWS, AMAZON S3, GOOGLE CLOUD, MICROSOFT AZURE, EMC, APACHE HADOOP, or others.

The expense reporting application 112 comprises computer-executable stored program instructions including, but not limited to, trip event extraction instructions 114, trip event analyzation instructions 116, segmentation instructions 118, expense generation instructions 120, and presentation instructions 122. Each of the computer-executable stored program instructions can be programmed to call functions, methods, or application programming interfaces (APIs) to retrieve information from various multiple travel-related data from the one or more user computers 102a-102n, the one or more server 104a-104n and/or the travel record database 110 associated with the travel planning application 106.

The trip event extraction instructions 114 are programmed or configured to query the travel planning application 106 and/or access the travel record database 110 to retrieve the planned trip records 108a-108n. The records 108a-108n may be user-specific or employee-specific and can be analyzed based on an employee's role in the enterprise or company. The records 108a-108n may contain trip information including, but not limited to, user or employee account information that directly or indirectly specifies the enterprise or company the user or employee is associated with, user role or employee role in the enterprise, for example, employee's role is manager, partner, CEO, director, etc., eligibilities that depend on the user or employee role, for example, the expense limit value and travel offers approved for the user or employee for traveling, various bookings, reservations and appointments at different locations, multiple trip itineraries containing details of trip event data, for example, an arrival date value, an arrival time value, a departure date value, and a departure time value. The records 108a-108n may also specify the agenda of the user or employee travel plans and/or travel bookings; for example, the agenda is network development, setting up work or business meetings, etc. The records 108a-108n may also comprise different lodging event data and movement or transit event data. The lodging event data may be associated with a lodging location, including city and country name, for example, hotel reservations, check-in time relative to arrival date and arrival time at the hotel room, and check-out time relative to the departure date and departure time from the hotel room. The movement or transit event data may be associated with commutation, for example, flight travel, train mode of movement or transit, rental modes like rental cars of transportation, sharing of rides, taxi commutes, or movement or transit that is associated with pickup date, pickup time, pickup location, return date, return time, and return location.

Each of the lodging event data and the movement or transit event data includes a plurality of schedule values for the number of distinct locations. The schedule values may include arrival time, arrival date, departure time, and departure date, the lodging location including city and country name, check-in time relative to arrival date and arrival time, and check-out time relative to the departure date and departure time, and the commutation that is associated with pickup date, pickup time, pickup location, return date, return time, and return location, determined from the multiple pieces of trip itineraries. The records 108a-108n may also include meal data for meals like breakfast, lunch, dinner, snacks, etc. The one or more planned trip records 108a-108n may include all the details and information offered by the enterprise to the user or employee for travel plans and/or travel bookings. In an embodiment, each of the records 108a-108n can be queried as of the time of this writing, for example, AMADEUS, SABRE, TRAVELPORT, FLIGHTLOGIC, EXPEDIA, RATEGAIN, MAKCORPS, HOTELBEDS, WEBBEDS, BONOTEL, RENTALCARS, CARTRAWLER, and others. In an embodiment, the records 108a-108n may be created or updated for the user's travel plan and/or travel bookings in the past, or at the present time and/or created for upcoming events, and associated with either pre-approval and/or post-approval requests.

The trip event analysis instructions 116 are programmed or configured to determine event data specifying the plurality of schedule values that include, but are not limited to, the arrival date value, the arrival time value, the departure date value, and the departure time value for each distinct location among a plurality of locations, from the one or more planned trip records 108a-108n. In an embodiment, the arrival date value, the arrival time value, a departure date value, and the departure time value may be associated with the lodging event data and the movement or transit event data associated with one another and correspond to distinct locations. TABLE 1 illustrates an example of lodging event data associated with the movement or transit event data corresponding to the distinct locations for a round trip plan and/or travel bookings:

TABLE 1

XYZ Flight
San Francisco -> Paris
2021/08/01 22:00 -> 2021/08/02 07:00
ABC Hotel
Paris
2021/08/02 11:00 -> 2021/08/06 17:00
Flight
Paris -> San Francisco
2021/08/06 20:00 -> 2021/08/07 06:00

The above example defines a trip specifying city locations and timings for an example in which a user plans to depart using XYZ Flight San Francisco 2021/08/01 at 22:00, arriving at Paris 2021/08/02 at 07:00. Further, the above example defines the employee's lodging details with location and check-in timings to specify that lodging at ABC Hotel in Paris on 2021 Aug. 2 with check-in time 11:00 at the hotel. The employee is defined with departure time from the ABC Hotel as 2021/08/06 with a check-out date and time of 17:00. The example defines return flight details specifying city locations and timings from where the employee is returning via flight travel from Paris on 2021 Aug. 6 with a departure time of 20:00 and arriving at San Francisco with arrival date 2021/08/07, arrival time 06:00.

The segmentation instructions 118 are programmed or configured to create or update an expense record having one or more travel segments based on the plurality of schedule values of the event data and associated with the plurality of distinct locations like the example above. For example, segmentation instructions 118 determines all distinct locations with the earliest and latest time that the user or employee traveled to and/or planned to travel to. By determining one or more travel segments based on the event data associated with the earliest and latest time that the user or employee traveled to and/or planned to travel to, a per diem modal is created or updated with all the entries determined by trip event extraction instructions 114, the trip event analysis instructions 116, and the segmentation instructions 118. Based on the per diem modal, the expense record having the one or more travel segments is created and/or updated. In this context, “per diem modal” can be implemented using a programmatic function.

TABLE 2 shows an example of creating and/or updating expense records with one or more travel segments based on the schedule values of the event data and associated with the plurality of distinct locations.

TABLE 2

| Trip way(s) | Trip Scenario | Per Diem Modals |
|---|---|---|
| Round-trip single- | Flight | Start with Travel |
| leg trip with flight | San Francisco -> Paris | Travel Segment 1 |
| and hotel | 2021 Aug. 01 22:00 -> | (From Flight details): |
| *Round Trips/trips | 2021 Aug. 02 07:00 | Travel City: San Francisco |
| with the same start | Hotel | Departure Date and Time: |
| and end city will | Paris | 2021 Aug. 01 22:00 |
| have “Final | 2021 Aug. 02 11:00 -> | Travel Segment 2: |
| Destination” | 2021 Aug. 06 17:00 | Travel City (From Flight |
| checked | Flight | details): Paris |
| | Paris -> San Francisco | Arrival Date and Time |
| | 2021 Aug. 06 20:00 -> | (From Flight details): |
| | 2021 Aug. 07 06:00 | 2021 Aug. 02 07:00 |
| | | Departure Date and Time |
| | | (From Flight details): |
| | | 2021 Aug. 06 20:00 |
| | | Travel Segment 3: |
| | | Travel City |
| | | (From Flight details): |
| | | San Francisco |
| | | Arrival Date and Time |
| | | (From Flight details): |
| | | 2021 Aug. 07 06:00 |
| | | Check “Final Destination” |

The expense generation instructions 120 are programmed or configured to automatically determine one or more daily allowed expense items for each travel segment of the one or more travel segments and automatically update the expense record to specify the one or more daily allowed expense items as expense line items in the expense record. In an embodiment, the expense generation instructions 120 applies a plurality of digitally stored per diem reimbursement rules and the policy data to automatically determine the one or more daily allowed expense items for each travel segment of the one or more travel segments and automatically update the expense record to specify the one or more daily allowed expense items as expense line items in the expense record. In an embodiment, the plurality of digitally stored per diem reimbursement rules and the policy data is stored in the travel record database 110 and/or the expense record database 124. The digitally stored per diem reimbursement rules may specify a plurality of per diem categories that correspond to enterprise-specific, user- or employee-specific, employee's role, and eligibility limit value of the employee. The policy data may be related to country-based, city-based, zone-based, and corresponding government-based per diem policy statistics, per diem rates, tax rates, excise rates, tolls, tariffs, prices, costs, charges, and other related per diem expenses that are required to evaluate daily allowed expense items for each travel segment. In an embodiment, digitally stored per diem reimbursement rules may specify per diem categories corresponding to one or more per diem items relating to the lodging event data, movement or transit event data, the event with arrival date and time, departure date and time, meal types, and one or more per diem limit values corresponding to each of the per diem items. The expense generation instructions 120 are programmed or configured to receive a request to launch the expense reporting application 112 from the user account or employee account. Based on the reimbursement rules, the expense generation instructions 120 perform matching the user account or employee account to a particular user role value and automatically determine the one or more daily allowed expense items for each travel segment of the one or more travel segments only when the eligibility value associated with the user role value indicates eligibility.

The presentation instructions 122 are programmed or configured to provide a visual representation of each evaluation of the per diem allowance expenses and updated expense record for each travel segment specifying each daily allowed expense line item for travel plans and/or travel bookings. The presentation instructions 122 cause displaying interface elements for receiving input specifying a request to add details of the planned trip records 108a-108n that have been retrieved from or previously created in the travel planning application 106. Presentation instructions 122 further cause displaying a prompt for each stage of evaluation of the per diem allowance expenses and updated expense record for each travel segment specifying each daily allowed expense line item for travel plans and/or travel bookings. In one embodiment, presentation instructions 122 further display a prompt for reviewing and updating an imported trip itinerary. For example, the prompt for any of the stages of evaluating the per diem allowance expenses, the updated expense record for each travel segment, and for reviewing and updating the imported trip itinerary may be displayed as a graphical bar. In a preferred embodiment, presentation instructions 122 may display the graphical bar for the prompt.

Presentation instructions 122 further specify one or more trip event groups of the event data that are classified based on any of 1) any missing information from the planned trip record and the event data associated with the plurality of distinct locations, and 2) the review of the imported trip itinerary that can contain incorrect information and needs an update. The event data specifying the plurality of schedule values may include the arrival date value, the arrival time value, the departure date value, and the departure time value for each distinct location among the plurality of locations are digitally stored in the one or more trip event groups and presented with the visual representation associated with the interface elements. The interface elements include but are not limited to icons, drop-down menus, radio button options, checkboxes, drop-down menus, drag-and-drop selections, and text fields. In an embodiment, the prompt relating to the review of the imported trip itinerary and the event data contains correct information or incorrect information for updating are visually indicated using one or more indicators including, but not limited to, visual indicators, visual noise, flag indicators, highlight indicators, labeling indicators, tagging indicators, pointer indicators, classifier indicators and other kinds of prompt indicators that can trigger the attention of the reviewer which can include employee or request submitter, and approvers like AP team or auditors updating the information of the travel plans and/or the travel bookings. The display of GUI with the visual representation of travel plans and/or travel bookings and the evaluation of expense records for each travel segment with the daily allowed per diem expenses for each expense item is described in later sections herein.

### 2.2 Example Programmed Process of Automatically Determining Per Diem Items and Expense Lines Based on Trip Data

### 2.2.1 Process Overview

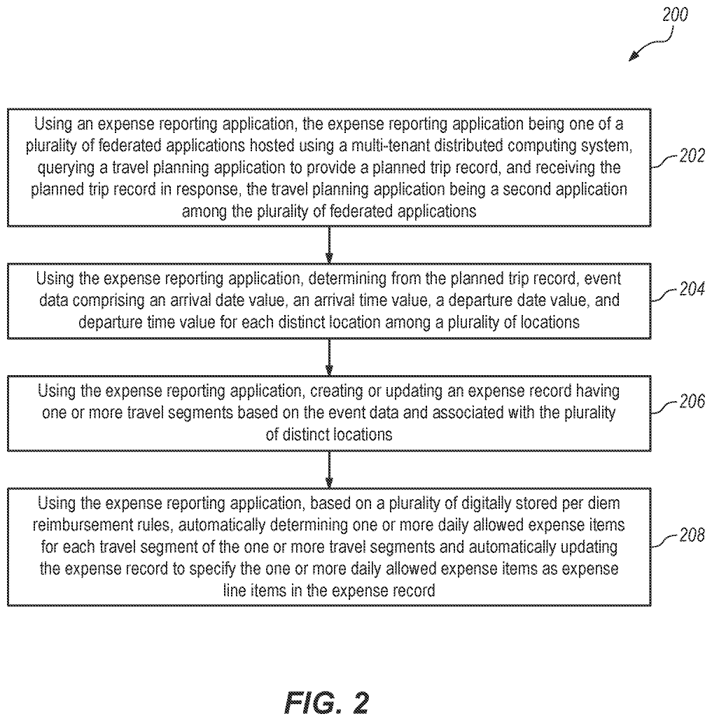

FIG. 2 depicts an example flowchart for a process that can be programmed for one embodiment. The example of FIG. 2 is programmed for evaluating one or more daily allowed expense items for each travel segment of the one or more travel segments and automatically updating the expense record to indicate the one or more daily allowed expense items as expense line items in the expense record along with providing the evaluation of the one or more daily allowed expense items on a graphical user interface (GUI) that may be facilitated by the expense reporting application 112, according to an embodiment.

Process 200 provides automated and touchless per diem entries; for example, the process is programmed to automatically enter itinerary data from COUPA travel booking to determine the per diem allowance. The process 200 uses the expense reporting application 112, which can be the first application among the plurality of federated applications that are hosted using the multi-tenant distributed computing system or federated system 126.

Process 200 begins at step 202, which is programmed to query the travel planning application 106 to provide the planned trip records 108a-108n. In an embodiment, the travel planning application 106 is a second application among the plurality of federated applications. The records 108a-108n may be user-specific or employee-specific and are analyzed based on the employee's role in the enterprise or company. The records 108a-108n may contain trip information including, but not limited to, user or employee account information that directly or indirectly specifies the enterprise or company the user or employee is associated with, user role or employee role in the enterprise, for example, employee's role is manager, partner, CEO, director, etc., eligibilities that depend on the user or employee role, for example, the expense limit value and various travel offers approved for the user or employee for traveling, various bookings, reservations, and appointments at various locations, multiple trip itineraries containing details of trip event data specifying schedule values, for example, an arrival date value, an arrival time value, a departure date value, and a departure time value. The records 108a-108n may also specify the itinerary or agenda of the user or employee, travel plans, and/or travel bookings; for example, the agenda could list network development, setting up work or business meetings, etc.

The records 108a-108n may also comprise different event data associated with lodging, movement, or transit. The lodging event data may be associated with lodging location, including city and country name, for example, hotel reservations, check-in time relative to arrival date and arrival time at the hotel room, and check-out time relative to the departure date and departure time from the hotel room. The movement or transit event data may be associated with commutation, for example, flight travel, train mode of movement or transit, rental modes like rental cars of transportation, or movement or transit, that is associated with pickup date, pickup time, pickup location, return date, return time, and return location. Each of the lodging event data and the movement or transit event data includes but is not limited to, the number of distinct locations with different schedule values specifying arrival time, arrival date, departure time, and departure date, the lodging location, including city and country name, check-in time relative to arrival date and arrival time, and check-out time relative to the departure date and departure time, and the commutation that is associated with pickup date, pickup time, pickup location, return date, return time and return location, determined from the multiple pieces of trip itineraries. In an embodiment, the trip information, the lodging event data, the movement data, or the transit event data indicate the plurality of per diem categories and one or more per diem limit values corresponding to each of the per diem items.

The records 108a-108n may include meal data for meals like breakfast, lunch, dinner, snacks, etc. The one or more planned trip records 108a-108n may include all the details and information that are offered by the enterprise to the user or employee for travel plans and/or travel bookings. In an embodiment, the records 108a-108n may be created or updated for the user's travel plan and/or travel bookings in the past or at present time and/or created for upcoming events, and associated with either pre-approval and/or post-approval requests.

At step 204, the expense reporting application 112 determines event data comprising a plurality of schedule values, for example, the arrival date value, the arrival time value, the departure date value, and the departure time value for each distinct location among the plurality of locations. In an embodiment, the expense reporting application 112 determines the event data from planned trip records 108a-108n. The arrival date value, the arrival time value, the departure date value, and the departure time value may be associated with the lodging event data and the movement or transit event data that are linked to one another and correspond to distinct locations. Examples of lodging event data associated with movement or transit event data corresponding to distinct locations for different segments of a trip are illustrated below:

XYZ Flight
San Francisco -> Paris
2021/08/01 22:00 -> 2021/08/02 07:00
ABC Hotel
Paris
2021/08/02 11:00 -> 2021/08/06 17:00
Flight
Paris -> San Francisco
2021/08/06 20:00 -> 2021/08/07 06:00

The above example defines a trip specifying city locations and times of travel. One element specifies departing on XYZ Flight from San Francisco on 2021 Aug. 1 at 22:00, and arriving in Paris on 2021 Aug. 2 at 07:00. Further, the above example defines the employee's lodging details with location and check-in timings. For example, the employee could be lodging at ABC Hotel in Paris on 2021 Aug. 2 with a check-in time of 11:00. The employee also is associated with a departure date and time from the hotel, such as 2021/08/06 and 17:00. The example defines a return flight from Paris on 2021 Aug. 6 with a departure time of 20:00 and arriving at San Francisco on 2021 Aug. 7 at 06:00.

At step 206, the expense reporting application 112 is used for creating or updating the expense record having the same one or more travel segments based on the event data and associated with the plurality of distinct locations. The creation or updating of expense records with travel segments is illustrated in more detail in FIG. 3.

Referring again to FIG. 2, at step 208, expense reporting application 112 applies digitally stored per diem reimbursement rules to automatically determine one or more daily allowed expense items for each travel segment of the one travel segment. The digitally stored per diem reimbursement rules may correspond to enterprise-specific and government-specific per diem reimbursement rules and policies stored in the expense record database 124. In an embodiment, the digitally stored per diem reimbursement rules specify a plurality of per diem categories. Each of the categories may correspond to the user or employee role value, for example, execute role or non-executive role, the eligibility value that depends on the user role value, one or more per diem items, for example, hotel, rental cars transportation, etc., and one or more per diem limit values corresponding to each of the per diem items, for example, maximum expenses spendable and allowed for the user.

Based on a plurality of digitally stored per diem reimbursement rules, the user account is matched with a particular user role value. The one or more daily allowed expense items for each travel segment of the one or more travel segments is determined automatically only when the eligibility value associated with the user role value indicates eligibility. In an embodiment, the process is programmed to automatically update the expense record to specify the one or more daily allowed expense items as expense line items in the expense record.

### 2.2.2 Determining Trip Segments

FIG. 3 illustrates a process flow or algorithm that can be programmed to trigger application programming interface (API) calls for determining expense records with trip segments, according to an embodiment. The program instructions 114, 116, 118, 120, and 122 (FIG. 1) can implement one or more aspects of FIG. 3.

In the example of FIG. 3, a programmed process 300 begins at step 302, which is programmed to receive user input by selecting an “Add Trip Details” button 314 or a functionally equivalent widget of a graphical interface. Assume that the trip event extraction instructions 114 implement step 302. In response, the trip event extraction instructions 114 can be programmed to instruct presentation instructions 122 to present a graphical user interface having a plurality of data entry widgets that are programmed to receive input specifying trip details for a proposed trip, such as trip dates and locations. A GUI like that of FIG. 4, described in further detail below, can be used.

After user input completes specifying the trip details, at step 304, process 300 is programmed to transmit a programmatic call to a travel API to request determining one or more trip segments from the trip details and one or more per diem items that apply to the trip segments.

Steps 306, 308 represent executing an API function to determine trip segments based on trip data. In step 306, trip details such as departure and end locations and departure and end times are extracted from the API call. API calls can analyze and extract the plurality of schedule values indicating the arrival date value, the arrival time value, a departure date value, and the departure time value associated with each of the lodging event data and the movement or transit event data. For example, all distinct locations with the earliest and latest time that the user or employee traveled to, and/or planned to travel to, are extracted from the planned trip records 108a-108n. Below is an example of extracting trip event details associated with event data, lodging event data and movement or transit event data, and other trip information:

```
{
  start_location: ‘San Francisco’,
  departure_time: ‘2021-08-01 22:00’,
  end_location: ‘Paris’,
  arrival_time: ‘2021-08-01 10:00’,
}
```

At step 308, one or more travel segments, for example, expense trip segments, are built from the trip details extracted in step 306. FIG. 3 shows travel segments 316, indicating a departure city of San Francisco, CA, USA on a departure date of Aug. 11, 2021 at 10 PM, and a destination city of Paris, France with an arrival date of Aug. 12, 2021 at 7 AM, followed by a departure date of Aug. 14, 2021 from Paris. The expense trip segments can be updated to expense records or expense trip records. In an embodiment, updating an expense record specifies the daily allowed expense items as expense line items in the expense record. For example, the expense line items are updated as per diem lines in the expense record.

In an embodiment, the expense trip segments are retrieved via an API, and the earliest event and the latest event are determined to create travel segments and populate per diem. For calculating per diems and creating a travel segment, the start and end of each travel segment may be determined. To create trip segments, all distinct locations with the earliest and latest user travel time are determined and added. For example, when an employee travels to two different cities in a single day, details corresponding to both cities are added to the per diem modal function. Even though two cities are entered for the same day, rates for the last city may be applied for evaluating per diem expenses for travel plans and/or travel bookings. This way of populating every city for per diems enables the traveler and approver to access the trip details with complete transparency.

In an embodiment, when a user or employee creates a new trip in any of the plurality of federated applications, such as the travel planning application 106 and the expense reporting application 112, the user or the employee can book air, hotel, and car rental segments. The expense reporting application 112 is programmed to create a line in the trip report as an expense record when a booking is made. For example, when new reservations are made for the same trip, the reservations are added to the same trip report. In an embodiment, the user either manually enters or adds the expense lines including per diem lines or the expense reporting application 112 automatically adds the expense lines including applicable per diem lines.

In an embodiment, user input specifies an expense line and a per diem category that is selected from among multiple per diem categories. The per diem categories may comprise different scopes, for example, per diems for an executive role, per diems for non-executive roles, etc. Some users within the company may not be eligible or required to request per diems. In such a case, the user may manually create a per diem line. When the travel planning application 106 and the expense reporting application 112 are implemented in a multi-tenant system, the per diem categories can be configured differently for different instances of the applications that apply to different tenants or enterprises.

TABLE 3 illustrates an example logic that can be programmed to transform trip data of different types and details into one or more travel segments to which different per diem policies may apply to enable creating and/or updating an expense record with one or more travel segments along with per diem details based on the event data and associated with the plurality of distinct locations.

TABLE 3
TRANSFORMING TRIP DETAILS TO TRIP SEGMENTS

| TRIP WAY(S) | TRIP SCENARIO | PER DIEM MODALS |
|---|---|---|
| One-way single leg | Flight | Start with Travel |
| trip with flight and | San Francisco -> Paris | Travel Segment 1 (From |
| hotel | 2021 Aug. 01 22:00 -> | Flight details): |
| *Layovers are | 2021 Aug. 02 07:00 | Travel City: San Francisco |
| included in the | Hotel | Departure Date and |
| same flight | Paris | Time: 2021 Aug. 01 22:00 |
| segment. New trips | 2021 Aug. 02 11:00 -> | Travel Segment 2: |
| will not be created | 2021 Aug. 06 17:00 | Travel City (From Flight |
| | | details): Paris |
| | | Arrival Date and Time |
| | | (From Flight details): |
| | | 2021 Aug. 02 07:00 |
| | | Departure Date and Time |
| | | (From Hotel details): |
| | | 2021 Aug. 06 17:00 |
| Round-trip single | Flight | Start with Travel |
| leg trip with flight | San Francisco -> Paris | Travel Segment 1 |
| and hotel | 2021 Aug. 01 22:00 -> | (From Flight details): |
| *Round Trips/trips | 2021 Aug. 02 07:00 | Travel City: San Francisco |
| with same start and | Hotel | Departure Date and |
| end city will have | Paris | Time: 2021 Aug. 01 22:00 |
| “Final Destination” | 2021 Aug. 02 11:00 -> | Travel Segment 2: |
| checked | 2021 Aug. 06 17:00 | Travel City (From Flight |
| | Flight | details): Paris |
| | Paris -> San Francisco | Arrival Date and Time |
| | 2021 Aug. 06 20:00 -> | (From Flight details): |
| | 2021 Aug. 07 06:00 | 2021 Aug. 02 07:00 |
| | | Departure Date and Time |
| | | (From Flight details): |
| | | 2021 Aug. 06 20:00 |
| | | Travel Segment 3: |
| | | Travel City (From Flight |
| | | details): San Francisco |
| | | Arrival Date and Time |
| | | (From Flight details): |
| | | 2021 Aug. 07 06:00 |
| | | Check “Final Destination” |
| Round Trip Multi- | Flight | Start with Travel |
| leg Trips with | San Francisco -> Paris | Travel Segment 1 |
| Flights only | 2021 Aug. 01 22:00 -> | (From Flight details): |
| *Round Trips/trips | 2021 Aug. 02 07:00 | Travel City: San Francisco |
| with same start and | Flight | Departure Date and |
| end city will have | Paris -> Berlin | Time: 2021 Aug. 01 22:00 |
| “Final Destination” | 2021 Aug. 06 20:00 -> | Travel Segment 2: |
| checked | 2021 Aug. 06 23:00 | Travel City (From Flight |
| | Flight | details): Paris |
| | Berlin -> San Francisco | Arrival Date and Time |
| | 2021 Aug. 09 10:00 -> | (From Flight details): |
| | 2021 Aug. 09 23:00 | 2021 Aug. 02 07:00 |
| | | Departure Date and Time |
| | | (From Flight details): |
| | | 2021 Aug. 06 20:00 |
| | | Travel Segment 3: |
| | | Travel City (From |
| | | Flight details): Berlin |
| | | Arrival Date and Time |
| | | (From Flight details): |
| | | 2021 Aug. 06 23:00 |
| | | Departure Date and time |
| | | (From Flight details): |
| | | 2021 Aug. 09 10:00 |
| | | Travel Segment 4: |
| | | Travel City |
| | | (From Flight details): |
| | | San Francisco |
| | | Arrival Date and Time |
| | | (From Flight details): |
| | | 2021 Aug. 09 23:00 |
| | | Check “Final Destination” |
| Hotel Bookings and | Hotel | Start from Destination City |
| following flight | Paris | Travel Segment 1 |
| reservation | 2021 Aug. 02 11:00 -> | (From Hotel details): |
| *If first segment is | 2021 Aug. 06 17:00 | Travel City: Paris |
| hotel, the user has | Flight | Arrival Date and Time |
| already traveled to | Paris -> San Francisco | (From hotel check- |
| the destination city. | 2021 Aug. 06 22:00 -> | in): 2021 Aug. 02 11:00 |
| Since flight data to | 2021 Aug. 07 07:00 | Departure Date and Time |
| the travel city is not | | (From flight takeoff): |
| available, per diems | | 2021 Aug. 06 22:00 |
| will start from | | Travel Segment 2: |
| Destination city | | Travel City (From Flight |
| | | details): San Francisco |
| | | Arrival Date and Time |
| | | (From Flight details): |
| | | 2021 Aug. 07 07:00 |
| | | Check “Final Destination” |
| Round Trip flight | Flight | |
| with hotels | San Francisco -> Paris | |
| reservations in | 2021 Aug. 01 22:00 -> | |
| different cities | 2021 Aug. 02 07:00 | |
| | Hotel | |
| | Belgium | |
| | 2021 Aug. 02 11:00 -> | |
| | 2021 Aug. 06 17:00 | |
| | Hotel | |
| | Germany | |
| | 2021 Aug. 02 11:00 -> | |
| | 2021 Aug. 06 17:00 | |
| | Flight | |
| | Paris -> San Francisco | |
| | 2021 Aug. 06 20:00 -> | |
| | 2021 Aug. 07 06:00 | |

In an embodiment, based on the created travel segments, the expense records are updated with all the trip details as shown in the example TABLE 4. For example, the expense trip segment from the trip details is added to the expense trip record using the below algorithm:

TABLE 4

```
{
  start_location: ‘San Francisco’,
  start_at: ‘2021-08-01 22:00’,
  start_location_id: ″,
  end_location: ‘Paris’,
end_at: ‘2021-08-01 10:00’,
end_location_id: ″,
is_travel_segment: 0/1
}
```

At step 310, the trip segments are transmitted or sent to the front end associated with the presentation of the expense records with travel segments.

At step 312, the default trip details are also included in the expense records, updated as per diem lines for each travel segment.

### 3.0 Example Graphical User Interface

### 3.1 Obtaining Trip Details Automatically or Manually

FIG. 4 illustrates a portion of a graphical user interface with a visual presentation of a planned trip record associated with distinct locations, according to an embodiment. In the example of FIG. 4, a GUI 400 comprises a per diem travel window 402, which can be displayed in a web page or an application page after automatically importing trip data from a travel application for use in an expense application. GUI 400 comprises a notification 404 prompting the user to “confirm cities and dates for your trip” to indicate that the GUI is associated with data entry for a potential trip. The per diem travel window 402 comprises text fields, one or more interface elements, one or more prompts, a graphical bar with the prompts, and per diem policy details according to which the per diem is evaluated. In an embodiment, a notification bar 406 signals that the system has imported trip data automatically from a travel application and prompts the user to confirm the values for use in expense reporting and calculation of per diem policy details relating to what per diem allowance covers and reimbursements that cannot exceed the per diem allowance.

Next, a graphical bar 408 displays to ask the requester or approver to confirm the trip details for the travel bookings. GUI 400 further displays interface elements such as a first radio button 410a for choosing the “travel to destination” and a second radio button 410b for choosing “start at a destination” option. The GUI 400 is programmed to dynamically update, by executing browser-executable code such as JAVASCRIPT, in response to selection of one of the radio buttons.

GUI 400 further displays a text field for location-specific data, such as start city 412, destination city 414, 416, and end city 418. Each of the city text fields is associated with values for an arrival date, arrival time, departure date, and departure time. User input to GUI widgets 412a, 412b, can specify the departure values for a start city. User input to GUI widgets 414a, 414b, 414c, 414d can specify the foregoing fields for a first destination city. User input to GUI widgets 416a, 416b, 416c, 416d can specify the foregoing fields for a second destination city. User input to GUI widgets 418a, 414b, can specify the arrival values for a final destination city or end city. The arrival date and time can be chosen with a drop-down menu for example.

Each of the trip schedules with arrival date and time and departure date and time for different locations can be added via GUI widgets 422, 424a, 426a, 428a, and can be deleted via interface elements 424b, 426b, 428b. Graphical icons such as “+” and “X” can visually indicate the function of the foregoing GUI widgets. A GUI widget such as checkbox 420 can be used to signal that the end city 418 is the final destination in the travel plan, and unchecking that checkbox can cause the GUI 400 to present a blank set of GUI widgets for an additional city. The user can click on cancel button 430 to cancel the process of pre-approval.

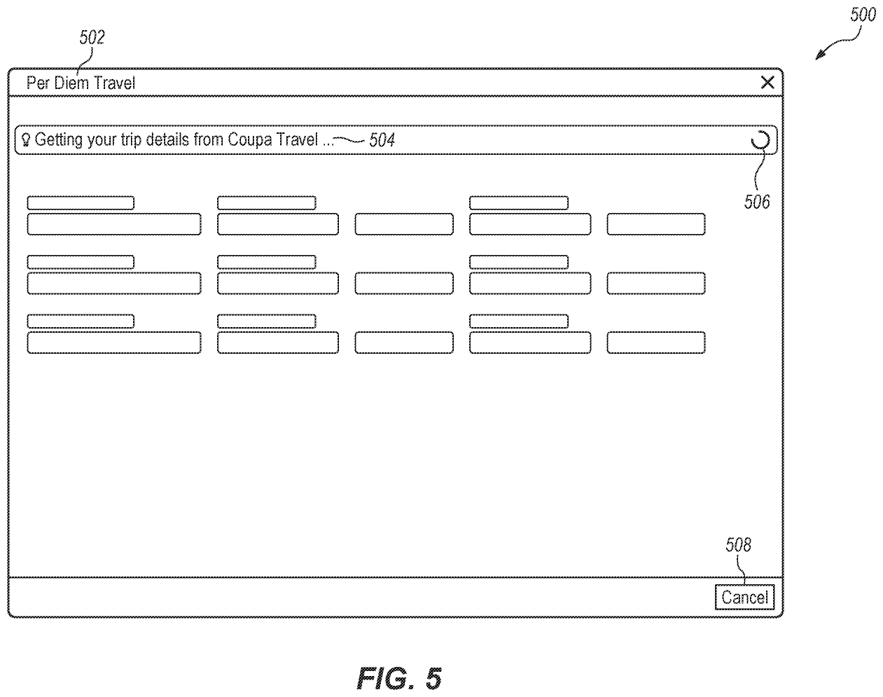

Assume that all data in FIG. 4 is viewed and confirmed, or updated using the GUI widgets. Upon confirming all the details of the trip plan, selecting the “Next” button 432 causes the GUI 400 to transition to the display of FIG. 5 for the evaluation of the per diem allowance according to travel segments and expense trip details.

In an embodiment, the prompt to review, confirm, fill out and update the imported trip itinerary and the event data like arrival date and time, departure date and time, can be indicated with at least one of one or more prompt indicators comprising visual indicators, visual noise, flag indicators, highlight indicators, labeling indicators, tagging indicators, pointer indicators, classifier indicators and other kinds of prompt indicators. For example, any required field that is missing information is highlighted. Users can manually enter any data to complete per diems if data is missing. Trip reports may have one per diem in each report.

FIG. 5 illustrates a portion of a graphical user interface with a visual presentation for indicating work in process for querying and extracting a planned trip record, according to an embodiment. The example of FIG. 5 shows an interstitial page of GUI 500 that is programmed for display while trip data is automatically retrieved from a travel application. When the expense reporting application 112 queries the travel planning application 106 for the planned trip records 108a-108n, trip event API is triggered to perform per diem travel evaluation 502. Toward the per diem travel evaluation 502, the trip details may be collected by the expense reporting application 112 as shown with bar 504. The graphical bar 506 represents a loading effect that reuses the shimmer component. GUI 500 is programmed with a “Cancel” widget 508 that can receive user input to cancel the import process and close the modal.

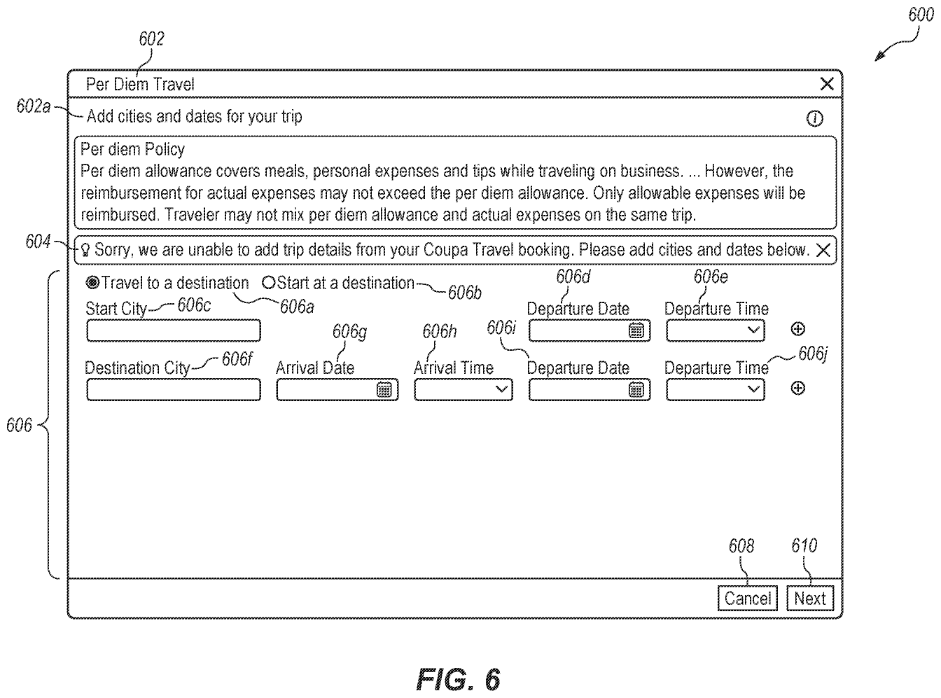

FIG. 6 illustrates a portion of a graphical user interface associated with updating trip details in an expense record to prompt the automatic calculation of per diem allowances. FIG. 6 shows an example GUI 600 that can be displayed, for example, when the automatic import of trip details from a travel application is impossible. In an embodiment, GUI 600 comprises a title bar 602 specifying an association with per diem travel calculation and a prompt 602a instructing users to add cities and dates for a trip shown in bar 604. The title bar also can include a summary of per diem reimbursement policy, customized based on a known role, level, or title of the user that is then currently logged in and receiving a presentation of the GUI.

In an embodiment, GUI 600 further comprises a notification bar specifying that automatic trip detail importing did not occur and prompting the user to enter cities and dates of travel using GUI widgets in a data entry panel 606. In an embodiment, panel 606 comprises two radio buttons 606a, 606b that are programmed to specify whether the other data in the panel is associated with travel to a destination or starting at a destination. Depending on which of the radio buttons 606a, 606b is selected via user input, GUI 600 is programmed to dynamically update panel 606 with different GUI widgets. In the example of FIG. 6, radio button 606a is selected so panel 606 shows a start city widget 606c and destination city widget 606f to specify points of travel. The start city widget 606c can be a text entry field or constrained field backed by a stored list of valid cities and is associated with a departure date widget 606d and departure time widget 606e, which can be implemented as a calendar picker widget and pull-down widget. Similarly, destination city widget 606f is associated with an arrival date widget 606g, arrival time widget 606h, departure date widget 606i and departure time widget 606j.

The user may edit trip detail and may confirm the details by clicking a “Next” button 610. In an embodiment, GUI 600 is programmed, in response to a selection of button 610, to form and store a trip record that includes the data specified in the widgets of panel 606, and to trigger the automatic creation of an expense line and the automatic calculation of applicable per diem items to be added to the expense line. User input to a “Cancel” button 608 can terminate the modal.

### 3.2 Receiving Input Specifying Exclusions of Allowed Per Diem Items

FIG. 7 illustrates a portion of a graphical user interface for evaluating allowed expense items as expense line items in expense records based on the selection of different expense items, according to an embodiment.

In an embodiment, GUI 700 of FIG. 7 is generated and presented automatically in response to creating or updating a trip record and after automatically determining applicable per diem items. In an embodiment, GUI 700 comprises a title bar 702 indicating an association with calculating per diem travel items. GUI 700 may comprise one or more prompt messages 704, 704a that specify, based upon per diem policies applicable to the user who is then currently logged in, what data needs to be entered. In the example of FIG. 7, the currently logged-in user needs to select all items that are allowed but the user wishes to exclude for each day of the trip and to select items that are allowed but should be excluded because the item(s) will be received without charge.

GUI 700 further comprises a table of allowed per diem items organized as a plurality of rows 708, 710, 712, 714, 716, 718, 720, each row corresponding to a day of the trip that had been specified automatically or manually via FIG. 3, FIG. 4, FIG. 5, FIG. 6. That is, after the departure, transit, and arrival dates for a trip have been specified either via automatic retrieval from a trip record of a travel application, or manual data entry, the number of rows and the data included in the rows 708, 710, 712, 714, 716, 718, 720 is calculated automatically. Thus, for other trips with other dates or locations, the number and content of rows in FIG. 7 would be different. In an embodiment, each of the rows 708, 710, 712, 714, 716, 718, 720 comprises a month-day designation like “08/13” for August 13, a day of the week label like “Fri”, and a location value in location column 706a, which is determined automatically from the previously obtained trip data.

Each row 708, 710, 712, 714, 716, 718, 720 further comprises one or more columns 706b, 706c, 706d, 706e, each of the columns being associated with a different type of reimbursable per diem item, based only policy applicable to the then currently logged-in user. In the example of FIG. 7, for the current user's trip on weekdays and weekends to “San Francisco, CA,” the system has retrieved applicable policy and calculated that per diem reimbursable items could include Breakfast, Lunch, Dinner, and Tips. Each cell at which a row 708, 710, 712, 714, 716, 718, 720 intersects with a column 706b, 706c, 706d, 706e comprises a checkbox GUI widget; user input to check one of the checkboxes indicates that the system should exclude the selected item from an automatic calculation of applicable per diem reimbursements.

GUI 700 further comprises a “Cancel” button 722 and a “Confirm” button 724. In an embodiment, the “Cancel” button 722 is programmed to cause closing the GUI 700 and end the modal. In an embodiment, the “Confirm” button 724 is programmed to save the exclusion data associated with each date, location, and per diem item column; the modal closes, and the result is shown in the per diem expense line of an expense report automatically.

### 3.3 Example Trip Segment Data Table and Relationship to Trip Data

FIG. 8 illustrates two portions of a graphical user interface showing expense trip segment data derived from user input and useful in implementing parts of FIG. 3, according to an embodiment. FIG. 8 comprises a combination GUI and backing data table 800. Referring again to FIG. 3, assume that user input at step 302 has selected an “Add Trip Details” button 314 after user input has specified the trip data shown in a GUI panel 802 of FIG. 8. In FIG. 3, in response, the system has programmatically called the Travel API at step 304. Then, the operation of the loop of steps 306, 308, for the data shown in GUI panel 802, results in creating and storing a trip segment table 804 comprising a plurality of rows, each of the rows corresponding to a segment of the trip that has been derived from the data entered in the GUI panel. The trip segment table 804 can be created and stored in expense record database 124 (FIG. 1).

In an embodiment, each of the rows in the trip segment table 804 comprises an attribute value for a starting date-time denoted “start-at” 806, a starting location time zone denoted “start timezone” 808a, a starting location denoted “start-location” 808b, an internal identifier of the starting location denoted “start_location_id” 810, an ending date-time denoted “end_at” 812, an ending location time zone denoted “end_timezone” 814, an ending location denoted “end_location” 816, an internal identifier of the ending location denoted “end_location_id” 818, a Boolean flag specifying whether the row corresponds to physical movement between locations and denoted “is_travel_segment” 820, an ordinal value specifying a segment identifier within a trip and denoted “segment_num” 822, and creation and update timestamp values denoted “created_at” 824, and “updated_at” 826.

In an embodiment, step 308 (FIG. 3) is programmed to automatically determine based on the user input for a trip, as in GUI panel 802, one or more segments including segments corresponding to the traveler's static presence in a location and movement between locations. For example, the data in GUI panel 802 shows that the traveler arrives in Paris, France on Aug. 20, 2021, and departs for Lyon, France on Aug. 22, 2021. Therefore, the location “Paris, France” is associated in the trip segment table 804 with two distinct segments. A first segment having “segment_num”=“1” is not a travel segment (having an “is_travel_segment” value of “0”) and represents the traveler's presence in Paris on August 20-21. A second segment “2” is a travel segment and represents the traveler's movement from Paris to Lyon on August 22-25. The identification of segments corresponding to static presence in a location and movement can be significant in applying the per diem policy for an enterprise and different reimbursable items may apply to each type of segment, resulting in different displays of allowed items in FIG. 7.

Similarly, the time zone of each location will affect the selection of allowed items in a display like FIG. 7. Various time zones could indicate that conventional meals of different types may or may not be appropriate. For example, the arrival time in a location, converted to local time, could result in a specification that “Breakfast” is an allowed item under the policy applicable to the traveler rather than “Dinner.” Logic for applying the time of a location with local time zone conversion, and determining the effect of an enterprise per diem policy, can be coded as part of step 308 or specified in rules stored in a table.

The internal location identifier values for locations can be normalized and/or based upon the APIs or policies of the servers 104a, 104n. For example, the location_id for a location can be programmatically fetched using a call to Google::Map::Place.autocomplete, providing a combination of City, State, Country Name. If there is any issue in calling such an external travel API, a blank array would be received, and null values would be placed in a row. Successful or failed API calls can be specified in the GUI panel 802 using notifications.

Referring again to FIG. 3, in an embodiment, the completion of step 308, resulting in the trip segment data seen in FIG. 8, table 804, can programmatically trigger passing the trip segment data to presentation instructions 122 (FIG. 1) to cause displaying the trip segment data as part of an expense report in a display device of the user computer 102a. For example, the call “Expenses::ExpenseTripSegmentsController #build_from_travel_trip” can be used at step 310 of FIG. 3 to pass trip segment data derived via FIG. 3 to the presentation layer.

### 4.0 Implementation Example—Hardware Overview

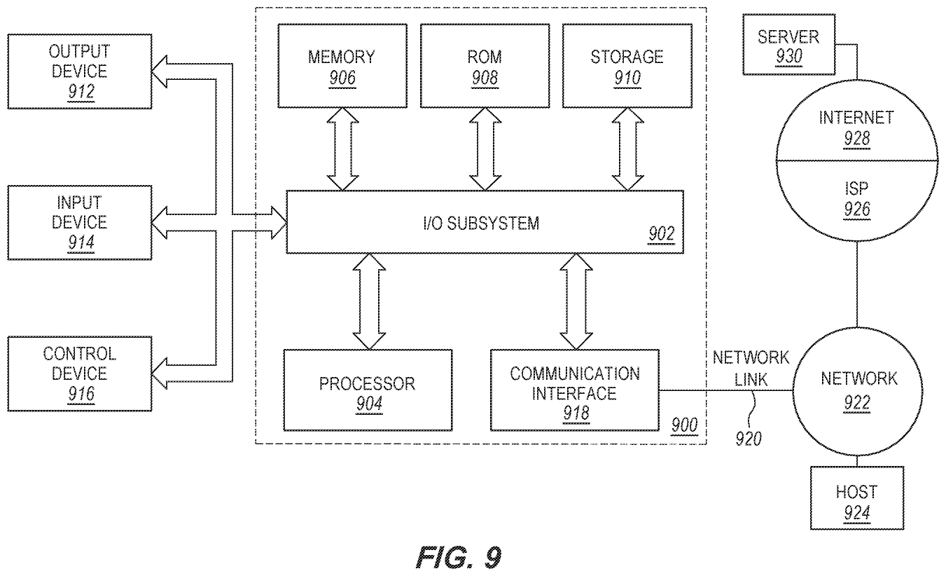

FIG. 9 is a block diagram that illustrates an example computer system with which an embodiment may be implemented. In the example of FIG. 9, a computer system 900 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 900 includes an input/output (I/O) subsystem 902 which may include a bus and/or other communication mechanisms (s) for communicating information and/or instructions between the components of the computer system 900 over electronic signal paths. The I/O subsystem 902 may include an I/O controller, a memory controller, and at least one I/O port. The electronic signal paths are represented schematically in the drawings, for example as lines, unidirectional arrows, or bidirectional arrows.

At least one hardware processor 904 is coupled to I/O subsystem 902 for processing information and instructions. Hardware processor 904 may include, for example, a general-purpose microprocessor or microcontroller and/or a special-purpose microprocessor such as an embedded system, a graphics processing unit (GPU), or a digital signal processor or ARM processor. Processor 904 may comprise an integrated arithmetic logic unit (ALU) or may be coupled to a separate ALU.

Computer system 900 includes one or more units of memory 906, such as a main memory, which is coupled to I/O subsystem 902 for electronically digitally storing data and instructions to be executed by processor 904. Memory 906 may include volatile memory such as various forms of random-access memory (RAM) or other dynamic storage devices. Memory 906 also may be used for storing temporary variables or other intermediate information during the execution of instructions to be executed by processor 904. Such instructions, when stored in non-transitory computer-readable storage media accessible to processor 904, can render computer system 900 into a special-purpose machine that is customized to perform the operations specified in the instructions.

Computer system 900 further includes non-volatile memory such as read-only memory (ROM) 908 or other static storage devices coupled to I/O subsystem 902 for storing information and instructions for processor 904. The ROM 909 may include various forms of programmable ROM (PROM) such as erasable PROM (EPROM) or electrically erasable PROM (EEPROM). A unit of persistent storage 910 may include various forms of non-volatile RAM (NVRAM), such as FLASH memory, or solid-state storage, magnetic disk, or optical disk such as CD-ROM or DVD-ROM and may be coupled to I/O subsystem 902 for storing information and instructions. Storage 910 is an example of a non-transitory computer-readable medium that may be used to store instructions and data which when executed by the processor 904 causes performing computer-implemented methods to execute the techniques herein.

The instructions in memory 906, ROM 908 or storage 910 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming, or other functions; data protocol instructions or stacks to implement TCP/IP, HTTP, or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server, or web client. The instructions may be organized as a presentation layer, application layer, and data storage layer such as a relational database system using a structured query language (SQL) or no SQL, an object store, a graph database, a flat file system, or other data storage.

Computer system 900 may be coupled via I/O subsystem 902 to at least one output device 912. In one embodiment, output device 912 is a digital computer display. Examples of a display that may be used in various embodiments include a touchscreen display, a light-emitting diode (LED) display, a liquid crystal display (LCD) or an e-paper display. Computer system 900 may include other type(s) of output devices 912, alternatively or in addition to a display device. Examples of other output devices 912 include printers, ticket printers, plotters, projectors, sound cards or video cards, speakers, buzzers or piezoelectric devices or other audible devices, lamps or LED or LCD indicators, haptic devices, actuators, or servos.

At least one input device 914 is coupled to I/O subsystem 902 for communicating signals, data, command selections or gestures to processor 904. Examples of input devices 914 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 916, which may perform cursor control or other automated control functions such as navigation in a graphical interface on a display screen, alternatively or in addition to input functions. Control device 916 may be a touchpad, a mouse, a trackball, or cursor direction keys for communicating direction information and command selections to processor 904 and for controlling cursor movement on an output device 912 such as a display. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism, or other types of control device. An input device 914 may include a combination of multiple different input devices, such as a video camera and a depth sensor.

In another embodiment, computer system 900 may comprise Internet of things (IOT) device in which one or more of the output device 912, input device 914, and control device 916 are omitted. Or, in such an embodiment, the input device 914 may comprise one or more cameras, motion detectors, thermometers, microphones, seismic detectors, other sensors or detectors, measurement devices or encoders and the output device 912 may comprise a special-purpose display such as a single-line LED or LCD display, one or more indicators, a display panel, a meter, a valve, a solenoid, an actuator or a servo.

When computer system 900 is a mobile computing device, input device 914 may comprise a global positioning system (GPS) receiver coupled to a GPS module that is capable of triangulating to a plurality of GPS satellites, determining and generating geo-location or position data such as latitude-longitude values for a geophysical location of the computer system 900. Output device 912 may include hardware, software, firmware, and interfaces for generating position reporting packets, notifications, pulse or heartbeat signals, or other recurring data transmissions that specify a position of the computer system 900, alone or in combination with other application-specific data, directed toward host computer 924 or server computer 930.

Computer system 900 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to one embodiment, the techniques herein are performed by computer system 900 in response to processor 904 executing at least one sequence of at least one instruction contained in main memory 906. Such instructions may be read into main memory 906 from another storage medium, such as storage 910. Execution of the sequences of instructions contained in main memory 906 causes processor 904 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage 910. Volatile media includes dynamic memory, such as memory 906. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 902. Transmission media can also take the form of acoustic or light waves, such as those generated during radio-wave and infrared data communications.

Various forms of media may be involved in carrying at least one sequence of at least one instruction to processor 904 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 900 can receive the data on the communication link and convert the data to a format that can be read by computer system 900. For example, a receiver such as a radio frequency antenna or an infrared detector can receive the data carried in a wireless or optical signal and appropriate circuitry can provide the data to I/O subsystem 902 such as placing the data on a bus. I/O subsystem 902 carries the data to memory 906, from which processor 904 retrieves and executes the instructions. The instructions received by memory 906 may optionally be stored on storage 910 either before or after execution by processor 904.

Computer system 900 also includes a communication interface 918 coupled to I/O subsystem 902. Communication interface 918 provides a two-way data communication coupling to network link(s) 920 that are directly or indirectly connected to at least one communication network, such as a network 922 or a public or private cloud on the Internet. For example, communication interface 918 may be an Ethernet networking interface, integrated-services digital network (ISDN) card, cable modem, satellite modem, or a modem to provide a data communication connection to a corresponding type of communications line, for example, an Ethernet cable or a metal cable of any kind or a fiber-optic line or a telephone line. Network 922 broadly represents a local area network (LAN), wide-area network (WAN), campus network, internetwork, or any combination thereof. Communication interface 918 may comprise a LAN card to provide a data communication connection to a compatible LAN, a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 918 sends and receives electrical, electromagnetic, or optical signals over signal paths that carry digital data streams representing various types of information.

Network link 920 typically provides electrical, electromagnetic, or optical data communication directly or through at least one network to other data devices, using, for example, satellite, cellular, Wi-Fi, or BLUETOOTH technology. For example, network link 920 may provide a connection through a network 922 to a host computer 924.

Furthermore, network link 920 may provide a connection through network 922 or to other computing devices via internetworking devices and/or computers that are operated by an Internet Service Provider (ISP) 926. ISP 926 provides data communication services through a world-wide packet data communication network represented as internet 928. A server computer 930 may be coupled to internet 928. Server computer 930 broadly represents any computer, data center, virtual machine, or virtual computing instance with or without a hypervisor, or computer executing a containerized program system such as DOCKER or KUBERNETES. Server computer 930 may represent an electronic digital service that is implemented using more than one computer or instance and that is accessed and used by transmitting web services requests, uniform resource locator (URL) strings with parameters in HTTP payloads, API calls, app services calls, or other service calls. Computer system 900 and server computer 930 may form elements of a distributed computing system that includes other computers, a processing cluster, a server farm, or other organization of computers that cooperate to perform tasks or execute applications or services. Server computer 930 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming, or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server computer 930 may comprise a web application server that hosts a presentation layer, application layer and data storage layer such as a relational database system using structured query language (SQL) or no SQL, an object store, a graph database, a flat file system or other data storage.

Computer system 900 can send messages and receive data and instructions, including program code, through the network(s), network link 920, and communication interface 918. In the Internet example, server computer 930 might transmit a requested code for an application program through Internet 928, ISP 926, local network 922, and communication interface 918. The received code may be executed by processor 904 as it is received, and/or stored in storage 910, or other non-volatile storage for later execution.

The execution of instructions as described in this section may implement a process in the form of an instance of a computer program that is being executed and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening several instances of the same program often means more than one process is being executed. Multitasking may be implemented to allow multiple processes to share processor 904. While each processor 904 or core of the processor executes a single task at a time, computer system 900 may be programmed to implement multitasking to allow each processor to switch between tasks that are being executed without having to wait for each task to finish. In an embodiment, switches may be performed when tasks perform input/output operations when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-implemented method comprising:
using an expense reporting application, querying a travel planning application to provide a planned trip record, and receiving the planned trip record in response, the expense reporting application being a first application of a plurality of federated applications hosted using a multi-tenant distributed computing system and the travel planning application being a second application among the plurality of federated applications;
using the expense reporting application, determining from the planned trip record, event data comprising a plurality of schedule values for each distinct location among a plurality of distinct locations;
using the expense reporting application, creating an expense record having one or more travel segments based on the event data and associated with the plurality of distinct locations;
using the expense reporting application, based on a plurality of digitally stored per diem reimbursement rules, automatically determining one or more daily allowed expense items for each travel segment of the one or more travel segments;
using the expense reporting application, automatically updating the expense record to indicate the one or more daily allowed expense items as expense line items in the expense record.

2. The computer-implemented method of claim 1, further comprising:
using the expense reporting application, executing steps of claim 1 in response to receiving an input specifying a request to add details of the planned trip record that has been previously created in the travel planning application.

3. The computer-implemented method of claim 1, further comprising:
using the expense reporting application, executing steps of claim 1 as part of a per diem modal function that is implemented as a programmatic function; and
generating and transmitting, to a user computer, sequences of presentation instructions which, when executed using the user computer, cause displaying a prompt to review and update an imported trip itinerary.

4. The computer-implemented method of claim 1, wherein the plurality of digitally stored per diem reimbursement rules specify a plurality of per diem categories, each of the plurality of per diem categories comprising a user role value, an eligibility value, one or more per diem items, and one or more per diem limit values corresponding to each of the one or more per diem items.

5. The computer-implemented method of claim 4, further comprising:
receiving, from a user account, a request to launch the expense reporting application; and
using the expense reporting application, based on the plurality of digitally stored per diem reimbursement rules, matching the user account to a particular user role value, and automatically determining the one or more daily allowed expense items for each travel segment of the one or more travel segments only when the eligibility value associated with the particular user role value indicates eligibility.

6. The computer-implemented method of claim 3, further comprising digitally storing in one or more trip event groups, the event data comprising the plurality of schedule values for each distinct location among the plurality of distinct locations, wherein the one or more trip event groups of the event data are classified based on any of:
any missing information determined from the planned trip record and the event data associated with the plurality of distinct locations, and
the review and the update of the imported trip itinerary.

7. The computer-implemented method of claim 6, further comprising indicating the prompt to review and update the imported trip itinerary and the event data with at least one of one or more prompt indicators.

8. A computer system, comprising:
one or more processors;
one or more non-transitory computer-readable media coupled to the one or more processors and storing one or more sequences of stored program instructions which when executed using the one or more processors cause the one or more processors to execute:
using an expense reporting application, querying a travel planning application to provide a planned trip record, and receiving the planned trip record in response, the expense reporting application being a first application of a plurality of federated applications hosted using a multi-tenant distributed computing system and the travel planning application being a second application among the plurality of federated applications;
using the expense reporting application, determining from the planned trip record, event data comprising a plurality of schedule values for each distinct location among a plurality of distinct locations;
using the expense reporting application, creating an expense record having one or more travel segments based on the event data and associated with the plurality of distinct locations;
using the expense reporting application, based on a plurality of digitally stored per diem reimbursement rules, automatically determining one or more daily allowed expense items for each travel segment of the one or more travel segments;
using the expense reporting application, automatically updating the expense record to indicate the one or more daily allowed expense items as expense line items in the expense record.

9. The computer system of claim 8, further comprising sequences of stored program instructions which when executed using the one or more processors cause the one or more processors to execute:
using the expense reporting application, executing steps of claim 8 in response to receiving an input specifying a request to add details of the planned trip record that has been previously created in the travel planning application.

10. The computer system of claim 8, further comprising sequences of stored program instructions which when executed using the one or more processors cause the one or more processors to execute:
using the expense reporting application, executing steps of claim 8 as part of a per diem modal function that is implemented as a programmatic function; and
generating and transmitting, to a user computer, sequences of presentation instructions which, when executed using the user computer, cause displaying a prompt to review and update an imported trip itinerary.

11. The computer system of claim 8, further comprising sequences of stored program instructions which when executed using the one or more processors cause the one or more processors to execute:
receiving, from a user account, a request to launch the expense reporting application; and
using the expense reporting application, based on the plurality of digitally stored per diem reimbursement rules, matching the user account to a particular user role value, and automatically determining the one or more daily allowed expense items for each travel segment of the one or more travel segments only when an eligibility value associated with a particular user role value indicates eligibility.

12. The computer system of claim 10, further comprising sequences of stored program instructions which when executed using the one or more processors cause the one or more processors to execute:
digitally storing in one or more trip event groups, the event data comprising the plurality of schedule values for each distinct location among the plurality of distinct locations, wherein the one or more trip event groups of the event data are classified based on any of:
any missing information determined from the planned trip record and the event data associated with the plurality of distinct locations, and
the review and the update of the imported trip itinerary.

13. The computer system of claim 12, further comprising sequences of stored program instructions which when executed using the one or more processors cause the one or more processors to execute:
indicating the prompt to review and update the imported trip itinerary and the event data with at least one of one or more prompt indicators.

14. One or more non-transitory computer-readable storage media, storing instructions which when executed cause one or more processors to execute:
using an expense reporting application, querying a travel planning application to provide a planned trip record, and receiving the planned trip record in response, the expense reporting application being a first application of a plurality of federated applications hosted using a multi-tenant distributed computing system and the travel planning application being a second application among the plurality of federated applications;
using the expense reporting application, determining from the planned trip record, event data comprising a plurality of schedule values for each distinct location among a plurality of distinct locations;
using the expense reporting application, creating an expense record having one or more travel segments based on the event data and associated with the plurality of distinct locations;
using the expense reporting application, based on a plurality of digitally stored per diem reimbursement rules, automatically determining one or more daily allowed expense items for each travel segment of the one or more travel segments;
using the expense reporting application, automatically updating the expense record to indicate the one or more daily allowed expense items as expense line items in the expense record.

15. The one or more non-transitory computer-readable storage media of claim 14, storing instructions which when executed cause the one or more processors to execute, using the expense reporting application, steps of claim 14 in response to receiving an input specifying a request to add details of the planned trip record that has been previously created in the travel planning application.

16. The one or more non-transitory computer-readable storage media of claim 14, storing instructions which when executed cause the one or more processors to execute, using the expense reporting application, steps of claim 14 as part of a per diem modal function that is implemented as a programmatic function; and
execute generating and transmitting, to a user computer, sequences of presentation instructions which, when executed using the user computer, cause displaying a prompt to review and update an imported trip itinerary.

17. The one or more non-transitory computer-readable storage media of claim 14, wherein the plurality of digitally stored per diem reimbursement rules specify a plurality of per diem categories, each of the plurality of per diem categories comprising a user role value, an eligibility value, one or more per diem items, and one or more per diem limit values corresponding to each of the one or more per diem items.

18. The one or more non-transitory computer-readable storage media of claim 17, storing instructions which when executed cause the one or more processors to execute:
receiving, from a user account, a request to launch the expense reporting application; and
using the expense reporting application, based on the plurality of digitally stored per diem reimbursement rules, matching the user account to a particular user role value, and automatically determining the one or more daily allowed expense items for each travel segment of the one or more travel segments only when the eligibility value associated with the particular user role value indicates eligibility.

19. The one or more non-transitory computer-readable storage media of claim 16, storing instructions which when executed cause the one or more processors to execute:
digitally storing in one or more trip event groups, the event data comprising the plurality of schedule values for each distinct location among the plurality of locations, wherein the one or more trip event groups of the event data are classified based on any of:
any missing information determined from the planned trip record and the event data associated with the plurality of distinct locations, and
the review and the update of the imported trip itinerary.

20. The one or more non-transitory computer-readable storage media of claim 19, storing instructions which when executed cause the one or more processors to execute:
indicating the prompt to review and update the imported trip itinerary and the event data with at least one of one or more prompt indicators.
